(19) United States
(12) Patent Application Publication
(10) Pub. No.: US 2012/0317287 A1
(43) Pub. Date: Dec. 13, 2012

(54) SYSTEM AND METHOD FOR MANAGEMENT OF DEVICES ACCESSING A NETWORK INFRASTRUCTURE VIA UNMANAGED NETWORK ELEMENTS

(76) Inventors: Ofer Amitai, Ramat Hasharon (IL); Nir Aran, Raanana (IL)

(21) Appl. No.: 13/493,322

(22) Filed: Jun. 11, 2012

Related U.S. Application Data
(60) Provisional application No. 61/495,557, filed on Jun. 10, 2011.

(51) Int. Cl. G06F 15/173

(52) U.S. Cl. 709/225

(57) ABSTRACT

A system and method for identifying devices whose access to a network infrastructure is unmanaged, and providing a capacity to a user to apply a management function to such connection. The unmanaged connections may be displayed or represented along with relevant information about the device and the connection, and a user may signal to apply a control function via such display.

### CROSS REFERENCE TO RELATED APPLICATIONS

This application claims the benefit of U.S. Provisional Application No. 61/495,557 filed on Jun. 10, 2011 entitled “MONITORING AND CONTROLLING ACCESS TO A NETWORK VIA AN UNMANAGED NETWORK ELEMENT”, incorporated herein by reference in its entirety.

### FIELD OF THE INVENTION

This application relates to access of electronic devices to a computer network, and particularly to identifying and managing devices that access a computer network via unmanaged network elements.

### BACKGROUND OF THE INVENTION

Electronic devices may connect or gain access to a network or network infrastructure by connecting through various access layers such as a wired network like an Ethernet, a wireless network such as a wireless access point, a virtual network such as a virtual local area network, a virtual private network (VPN) or by cloud-based access services. Some of such connections or access may be maintained through a managed switch or network access layer that may allow identification, management and control of such access.

Reference is made to FIG. 1, a schematic diagram of a control panel of a managed switch in accordance with the prior art. A managed switch 50 may include an indicator board 52 that may show ports 54 of the switch 50, a status indicator 56 (such as a green or red light) of a connection through such port 54, an identity indicator 58 of a device connected through such port 54, and other information about the connected device and the access granted to the device through port 54. The control panel may also allow for implementation by for example a user or information technology (IT) manager, of control of the access provided through one or more the ports 54 on the switch 50. The control panel may be part of the switch housing, or may be shown on a screen as a representation of the switch 50, ports 54 and their respective connections.

Connection of a device by way of an unmanaged element, such as by a hub, may not readily allow a network manager to be aware of, identify or control an access provided to the device, and may not readily facilitate regulation or control of the access by the device to a network resource or infrastructure.

### SUMMARY OF EMBODIMENTS OF THE INVENTION

Embodiments of the invention may include a method for managing access by a device to a network infrastructure where the devices gains access via an unmanaged network element. Embodiments of a method may include collecting from a managed network access layer that is connected to the network infrastructure, one or more unique identifiers (IDs) that are associated with or identify the device that is gaining access, identifying a group or set of the collected unique identifiers that are associated with devices that access the network infrastructure via an unmanaged network element, and applying a control to the access gained by such devices. In some embodiments, such control functions may be similar to the controls afforded to an access granted via a managed network element.

In some embodiments a method may include displaying a representation of a device that is associated with an identifier, where such devices accesses the network infrastructure via an unmanaged network element, and receiving or accepting a signal associated with the representation to apply the control function to the access granted to the device.

In some embodiments displaying includes depicting a representation of a port to indicate a connection to the network infrastructure by the device.

In some embodiments accepting a signal includes accepting a signal from an input device such as a mouse, touch screen or keyboard that is applied to an area of a display of the depiction of the representation.

In some embodiments, collecting includes collecting MAC addresses of devices that access the network infrastructure through the network access layer.

Some embodiments may include authenticating a device associated with a collected identifier.

In some embodiments, applying a control includes limiting access of the device to the network infrastructure.

In some embodiments applying the control includes blocking access by the device to the network infrastructure by way of a blocking function.

Some embodiments include querying an unmanaged network element for identifiers of devices receiving access to the network infrastructure via an unmanaged network element.

In some embodiments collecting unique identifiers includes collecting a list of devices accessing the network infrastructure via a managed port, and comparing the list with a list of all the unique identifiers and eliminating from the list the devices that gain access via managed ports, to derive a list of devices that gain access via unmanaged network elements.

In some embodiments, collecting unique identifiers may include collecting from access layers selected from the group of a managed switch, a router, a network bridge, a network multiplexer, a network proxy, a VPN concentrator, a wireless controller, a managed wireless access point and a firewall.

Embodiments of the invention may include a system for identifying devices accessing a network over unmanaged network elements, where such system includes a memory to store an identifier of each of a group of devices that access a network infrastructure, where a set of such identifiers is associated with devices accessing the network infrastructure via a managed network element. A system may also include a processor to send or issue a signal or request to network elements, where the signal requests such elements to send identifiers of devices accessing the network infrastructure by way of such network elements. The processor may exclude identifiers of the devices gaining access from managed ports from identifiers received in response to the request, and compile a list of devices accessing the network infrastructure via unmanaged network elements; and accept a signal to apply a control function to a device that gains unmanaged access.

In some embodiments, the processor is to issue a signal to display a list of devices gaining unmanaged access, including a representation of a port connecting the device to the network infrastructure. Such list and display may include information about the device and its access to the network infrastructure.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows a schematic diagram of a control panel of a managed switch of the prior art;

FIG. 2 shows a conceptual illustration of a network infrastructure configuration in accordance with an embodiment of the invention;

FIG. 3 shows a table of unique identifiers of devices that are detected as accessing a network infrastructure over managed connections and unmanaged connections in accordance with an embodiment of the invention;

FIG. 4 is a schematic representation of a control panel of a virtual or logical switch showing connections of devices to virtual or logical ports in accordance with an embodiment of the invention; and

FIG. 5 is a flow diagram in accordance with an embodiment of the invention.

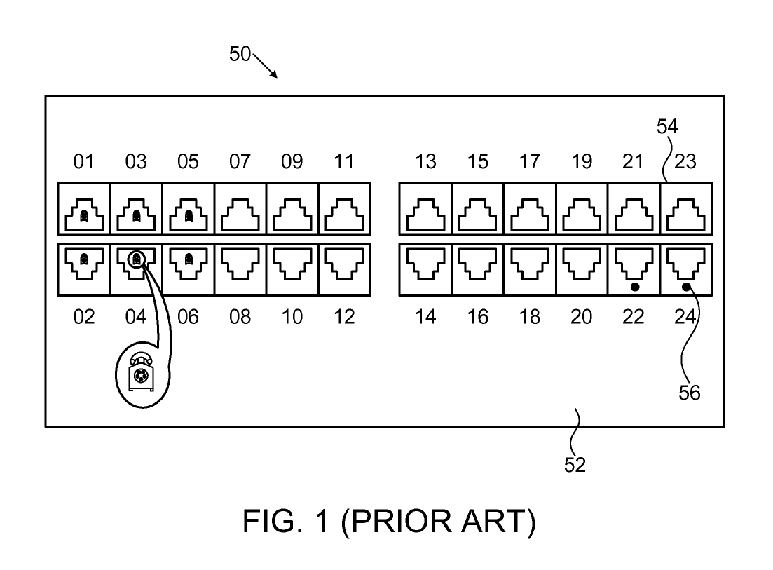

### DETAILED DESCRIPTION OF THE PREFERRED EMBODIMENTS

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example a processor or group of processors result in a method of an embodiment of the invention.

As used in this application, and in addition to its regular meaning, the term network resources may refer to one or more servers, data storage devices, processors, switches, PBX, or other electronic devices that may be connected to or accessible from a network (e.g., an electronic data network for sending or exchanging information) by other resources that are connected to or accessible from a network. For example, a network resource may include a database stored in a memory or disk drive, a server that may exchange data to and from a data storage device, a switch, a router, a hub, or one or more end user devices that may access or be accessed from one or more of the other network resources. The term network resource may include one or more networks that may be connected to or accessible from each other or from other devices.

As used in this application the term ‘identify a device’ may, in addition to its regular meaning, mean one or more identifiers of an electronic device, such as for example a Media Access Control (MAC) address, an Internet protocol (IP) address, a license number, a name of a user or registration number of a device, a model of a device or other identifying information that is sufficiently unique to determine an identity of the device. The term ‘unique’ when used herein may mean not duplicated within a certain environment, e.g., a network, or not likely to be duplicated within a certain environment, or in other embodiments not duplicated, or not likely to be duplicated, in any other network. Examples of such identifiers may include MAC addresses, IP addresses, software registration numbers and other such unique identifiers.

As used in this application, the term ‘manage or control” of an access by a device may, in addition to its regular meaning, include the capacity to cut off, stop, limit, regulate or otherwise apply one or more controls or control functions to the device or to access by the device to a network resource or infrastructure. For example, management of an access by a device, or application of a control or control function, may include the capacity to block access by the device to a network resource or infrastructure, to limit access by the device to particular network resources, to isolate the device in a particular network of virtual network, to limit access by the device to particular times or locations or to impose other limitations on the device or its access to the network. For example, a managed switch may permit one or more of the followings functions to be exercised: port range on/off, linking bandwidth and duplex setting, priority setting for ports, IP management by IP clustering, MAC filtering and port setting to prevent MAC flooding. In some embodiments, isolating a device may be accomplished by for example a knoxer available from Access Layers Ltd. of Herzlia Israel, by adding a command to an ACL (access list) on a router or firewall using standard command protocols such as SSH/Telnet , or by adding an ACL command on the switch using SNMP/SSH.

As used in this application, the term ‘unmanaged access’ by a device to a network infrastructure may, in addition to its regular meaning, imply the inability, incapacity (whether actual and objective inability, or simply unexercised ability) of a network manager or management tool to identify a device or assert control over an access by a device to a network resource, or to exercise one or more of the functions afforded in a managed connection.

As used in this application and in addition to its regular meaning, the term ‘network access layer’ may refer to one or more of an Ethernet switch, a router, a network bridge, a network multiplexer, a network proxy, a VPN concentrator, a wireless controller, a managed wireless access point, a firewall, or other managed connection to a network by which a device may connect to a network and from which a unique identifier of or associated with a device accessing a network via such network access layer may be collected or received.

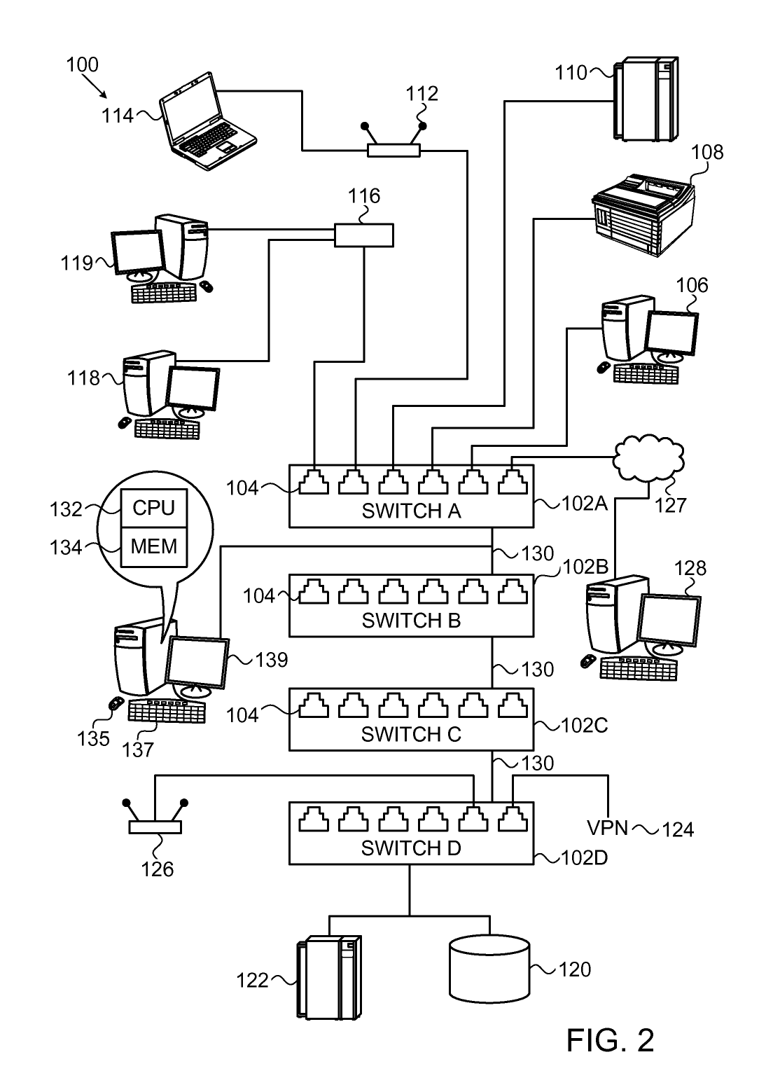

Reference is made to FIG. 2, a schematic diagram of network resources and access layers to such network resources, in accordance with an embodiment of the invention. A configuration of network infrastructure 100 may include one or more switches 102A, 102B, 102C and 102D. One or more of such switches 102 may be managed switches while others may be unmanaged. Some switches 102 may be capable of management but may be in an unmanaged state by a network administrator such that control functions may not be implemented or in a state to be exercised with respect to devices that gain access via such switch. Switch 102 may include a series of ports 104 that may allow a connection to switch 102A of devices, such as a computer 106 that may be connected via for example a wired Ethernet, a printer 108, a server 110, a wireless access point (AP) 112 that may provide wireless connectivity to a mobile device such as a laptop 114, and a hub 116 that may provide access to one or more computers or devices 118. One or more ports 104 may also provide connectivity via a cloud 127 based network to remote devices 128 or remote storage facilities. In some embodiments, ports 114 of another switch 102D may connect and provide access to a data storage unit 120 such as a collection of hard drives, a server 122 that may be associated with data storage 120, a VPN 124 and to another wireless access point 126. In some embodiments, one or more of switches 102A, 102B, 102C and 102D may be connected to each other by way of uplinks 130 that may carry network traffic between and among the switches.

In operation, a controller or processor 132 (which may be one or more processors) may monitor for example one or more uplinks 130 or other network connections or managed network access layers and may collect or receive data representing an identifier, such as a MAC address, of some or each of the devices to which, or from which, data is flowing on such uplink 130 or network access layer. A list of the collected identifiers may be stored in a memory 134 or elsewhere. The collected identifiers may be compared to identifiers of devices such as computer 106 and printer 108 that gain access from a port 104 that is managed or controlled by a user such as a network administrator or network administration tool. After accounting for or eliminating identifiers of devices on the list that access network infrastructure 100 by way of managed ports, the other identifiers of devices on the list may be assumed to represent devices, such as device 118, that access the network infrastructure 100 by way of unmanaged connections. Processor 132 may deliver or issue a signal, request, probe, query or sweep of the devices 118 and 119 and may request identifiers, e.g., request that such devices 118 and 119 identify themselves to processor 132 by providing unique identifiers of such devices.

In some embodiments, a list of devices 118 and 119 that gain access through unmanaged links such as hub 116 and access point 112, may be presented to a user in a display or on a screen, where such display is similar to that made available for ports of a managed switch, where such presentation includes a list of the devices, the status of their respective connections and other data, as well as control functions that may be implemented on the devices and their connections to network resources.

In some embodiments, the identification process of devices 118 and 119 that gain access through unmanaged connections may include, be followed by, be similar to or reflect an authentication process of such devices 118 and 119 to a network, and may allow processor 132 to determine whether such devices 118 are authorized or allowed to access network infrastructure 100. If one or more of such devices fails to qualify in the authentication process, a user may apply a management or control function to the access by the device.

In some embodiments, a system may include an input device such as a keyboard 137, mouse 135 or touch screen or other device by which a user may issue a signal to processor 132, and by which processor 132 may accept such signal. A system may also include a screen 139, display, monitor or other output device by which processor 132 may present an output or display such as a graphic display or user interface to a user, and through which a user may issue a signal to apply a function to a device represented on such screen.

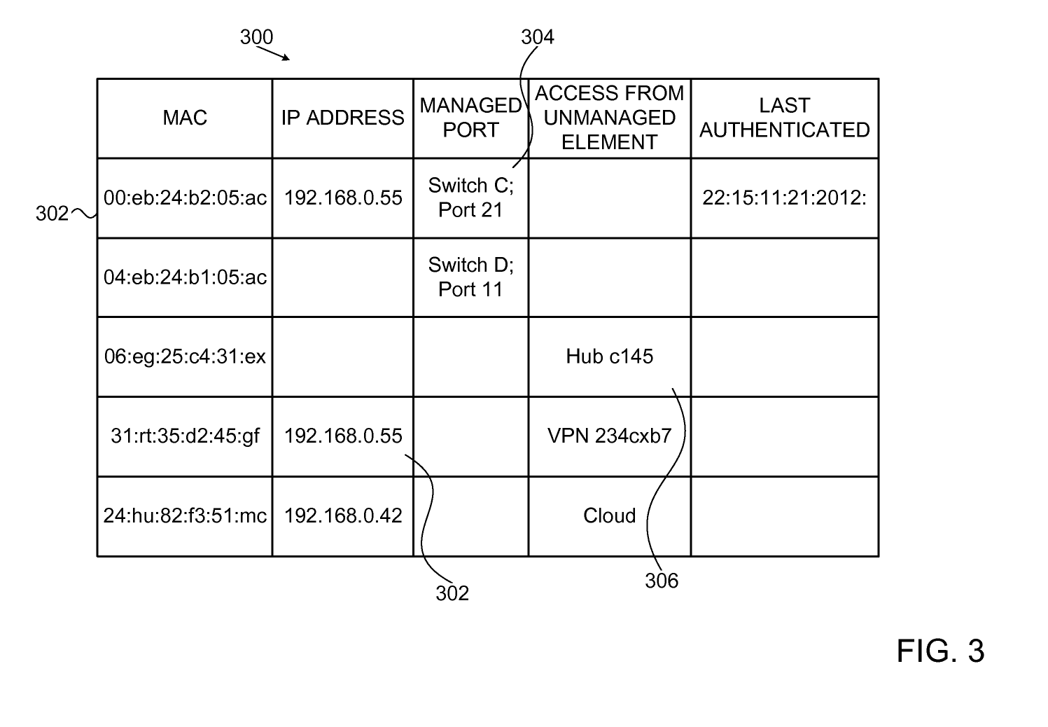

Reference is made to FIG. 3, a table of unique identifiers of devices that are detected as accessing a network infrastructure over managed connections and unmanaged connections in accordance with an embodiment of the invention. In some embodiments a list of unique identifiers of devices that access network infrastructure 100 may be assembled or compiled into a list or table 300 from for example packets or other data passing through uplink 130 or another network access layer. In some embodiments, probes or identification requests or signals may be issued or broadcast on a network, and responses to the probes may be added to a table of unique identifiers 302 of devices accessing the network infrastructure. Such unique identifiers may include one or more of MAC addresses, IP addresses, WindowsTM registry values, or other identifiers that may be associated with particular devices or network elements that access a network infrastructure. In some embodiments table 300 may include more than one unique identifier for a device.

In some embodiments, a network element such as a hub or other provider of unmanaged access may be detected, and a probe may be delivered to such element requesting identification of one, some or all of the devices that receive access via such element. Other ways to identify devices and populate a list of unique identifiers of devices accessing network infrastructure include the delivery of ARP Probes, UDP packets, and IDP packets.

Processor 132 may compare items, devices or unique identifiers on table 300 to a list 304 or registry of devices that access a network infrastructure 100 by way of managed connections such as those that receive access via a managed switch or a router, or may otherwise derive a table, list or entries that correlate to devices that access network infrastructure by way of connections that are not then managed or under the active control of a network administrator. Such list of devices that may provide unmanaged access may include for example Virtual private network systems, cloud connections or through a hub. In some embodiments, a device may connect by way of a port that has capacity for management, but that for some reason remains unmanaged or controlled by a network administrator. In some embodiments, the unique identifiers 302 of managed devices may be excluded or eliminated from the total list of unique identifiers 302 to derive a list of unmanaged devices 306.

A process of populating table 300 to identify the devices that access network infrastructure may be undertaken on a periodic or continuous basis, such as for example whenever a user or network administrator wants to know which devices are accessing the network at a particular time, or on a continuous basis so that a report of which devices were accessing a network resource may be assembled for all or certain hours of a day.

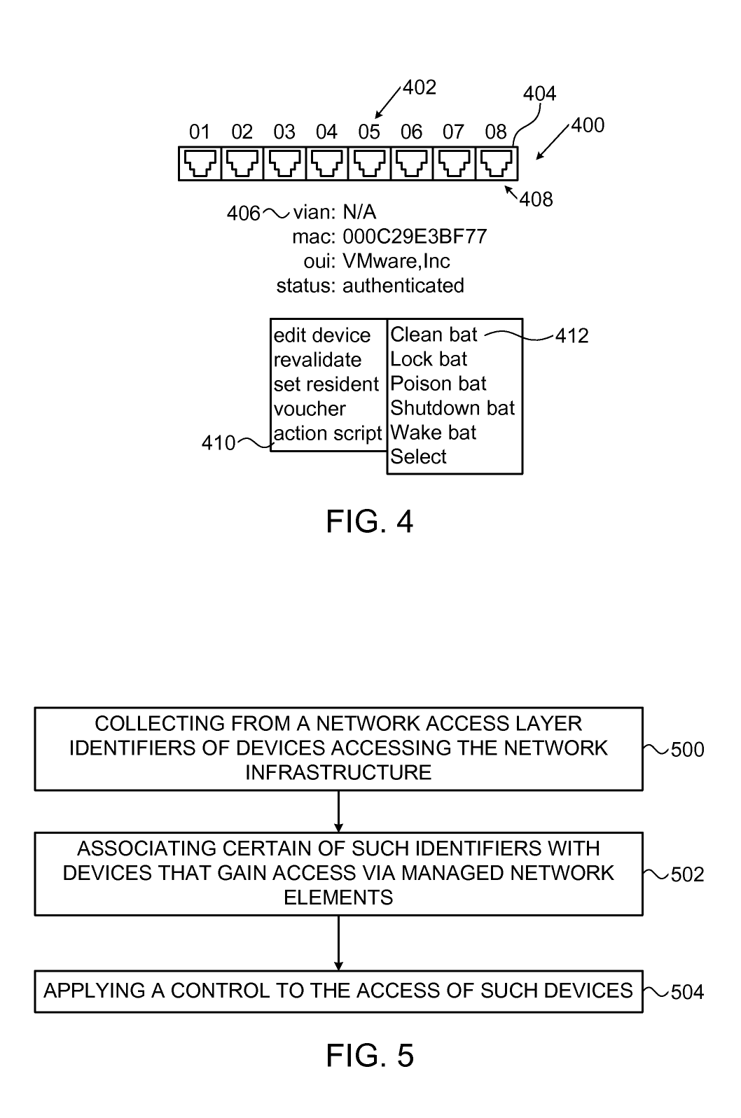

Reference is made to FIG. 4, a schematic representation of a control panel of a virtual switch or logical switch showing connections of devices to virtual or logical ports in accordance with an embodiment of the invention. Information technology managers and network administrators are accustomed to examining a control panel of a switch to determine which ports are used by which devices and to collecting information about a status of the connection. Embodiments of the invention present on a screen or monitor a display of a control panel 400 for a connection of a device to a network infrastructure even though such device may not be accessing the infrastructure through an actual port of a managed switch. Such display may include for example a representation of control panel 402 of a virtual switch, a representation or icons of a virtual or logical port 404 on the virtual switch and information about the connection of a device 406 through the virtual port 404. One or more colors of the icon representing the port 404, such as green, yellow or red may indicate a status, speed or other characteristics of the access. Other information that may be displayed includes one or more unique identifiers of the device that is connected through virtual port 404, an indication of the access layer (VPN, cloud, wireless, etc.) by which the device is connected, a designation of a network element (hub, access point, etc) via which such device is connected, and other information.

In some embodiments, control functions may be applied to the connection of the device by for example pointing a cursor 408 to the icon of port 404, and selecting one or more functions from a drop down list 410 that may be displayed near the icon of the port 404. By clicking a function on list 410, a user may signal a processor to implement or apply a control or control function to the connection of the device that is symbolized by the icon of port 404. A representation of the connection on control panel 402, the information on such connection displayed for port 404 that represents the connection, and the possibility of implanting a control function 412 from such representation may allow a user to manage an access of a device to a network infrastructure even though such access is via an unmanaged connection or unmanaged network element. Such functions 412 may include for example a cleaning process such as one to run a virus checker, a lock or blocking function as may block access from the connection, a poison function as may prevent or blacklist the device from accessing the network infrastructure in the future, a wake up function as may run a boot or log in, or other functions.

A processor may implement an authentication process for some or all of the devices that are identified or detected as accessing network infrastructure 100. Such authentication may determine if such devices are recognized by the network or satisfy other requirements of a pre-determined policy. An authentication status of one or more devices may also be displayed on control panel.

Reference is made to FIG. 5, a flow diagram of a method in accordance with an embodiment of the invention. Some embodiments may include managing access of a device to a network infrastructure, where the access of the device is via an unmanaged connection or network element. In block 500, a method may include receiving or collecting, e.g. from a switch or managed network access layer connected to the network infrastructure, a list, table or compilation of identifiers such as unique identifiers of devices that are accessing the network infrastructure. Such unique identifiers may be or include one or more of a MAC address, an IP address, a windows registry, device model registration number, operating system or other identifiers. A process of collecting identifiers of devices may include querying network elements such as unmanaged elements for data about devices to which such elements provide access or which receive access via the connection of such element to the network infrastructure. In block 502, certain of the collected identifiers may be associated with devices that may not be connected via a connection that is managed, and such set of devices may be deemed to be members of the group or part of a set or a compilation or collection of devices that gain access via unmanaged network elements. In block 504, a control may be applied to the access of such device to the network infrastructure.

In some embodiments, a representation of the connection of the device may be displayed on for example a screen or monitor, and a signal such as a pointing cursor or click of a mouse may be received or accepted to apply a control function to the connection represented on the display. Such a display may include for example a representation of a switch control panel where such representations include representations or icons of ports to indicate connections of devices. An icon may show information about the device and its connection. By clicking a mouse or other input device when a cursor points to an icon of a logical port, a user may select a signal to be received or accepted from a list of control functions that may be applied to the device or its connection and access to the network infrastructure. Such a control may include for example an order to issue a signal to block or limit access of the device to the network infrastructure or to isolate the access of the device to particular components of the network infrastructure. A part of the network infrastructure may accept such signal and exclude, limit or execute a blocking function to prevent an access by the device to one or more components of the network infrastructure.

In some embodiments, a method may continue to authenticate one or more of the devices whose access is otherwise unmanaged, and may apply an authentication or access policy to the connection.

In some embodiments, the list or compilation of devices that gain access from unmanaged elements may be derived by assembling a list of all devices gaining such access, and eliminating the devices on such list that gain access via managed elements. The remaining devices on such list may be those that access via unmanaged elements.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein. One or more processors, e.g., controller processor 132, may carry out methods as disclosed herein, e.g., by executing software or code, e.g., stored in memory 134.

It will be appreciated by persons skilled in the art that embodiments of the invention are not limited by what has been particularly shown and described hereinabove. Rather the scope of at least one embodiment of the invention is defined by the claims below.

We claim:

1. A method of managing access by a device to a network infrastructure, said access via an unmanaged network element, said method comprising:
collecting from a managed network access layer connected to said network infrastructure, a plurality of unique identifiers, each of said identifiers being associated with a device accessing said network infrastructure;
identifying a set of said plurality of unique identifiers, each member of said set of identifiers being associated with a device accessing said network infrastructure via an unmanaged network element; and
applying a control to said accessing of said network infrastructure by a device of said devices identified by said set of said plurality of identifiers.

2. The method as in claim 1, comprising:
displaying a representation of a first of said devices identified by said set of said plurality of identifiers; and
accepting a signal associated with said representation, said signal to apply said control to said accessing of said first of said devices.

3. The method as in claim 2, wherein said displaying comprises depicting a port, said depicting of said port indicating a connection to said network infrastructure by said device.

4. The method as in claim 2 wherein said accepting said signal comprises accepting a signal from an input device applied to an area of a display of said depiction.

5. The method as in claim 1, wherein said unique identifiers comprise MAC addresses of devices that access said network infrastructure through said access layer.

6. The method as in claim 1, comprising authenticating a device associated with an identifier in said set of said plurality of unique identifiers.

7. The method as in claim 1, wherein said applying said control comprises limiting said access to said network infrastructure by said device of said devices identified by said set of identifiers.

8. The method as in claim 1, wherein said applying said control comprises blocking access by said device to said network infrastructure.

9. The method as in claim 1, comprising querying an unmanaged network element for identifiers of devices receiving access to said network infrastructure via said unmanaged network element.

10. The method as in claim 1, wherein said identifying a set of said plurality of unique identifiers comprises identifying a device accessing said network infrastructure via a managed port.

11. The method as in claim 1, comprising identifying a second set of said plurality of unique identifiers each member of said second set of identifiers being associated with a device accessing said network infrastructure via a managed network element.

12. The method as inc claim 1, wherein said access layer is selected from the group comprising a managed switch, a router, a network bridge, a network multiplexer, a network proxy, a VPN concentrator, a wireless controller, a managed wireless access point and a firewall.

13. A system for identifying devices accessing a network over unmanaged network elements, comprising:
a memory to store an identifier of a plurality of devices, each of such devices accessing a network infrastructure, a first set of said devices accessing said network infrastructure via a managed network element,
a processor to:
issue a signal to a plurality of network elements requesting identifiers of devices accessing said network infrastructure by way of said network elements;
exclude identifiers of said first set of devices from identifiers received in response to said request;
compile a list of a second set of said devices, devices in said second set accessing said network infrastructure via unmanaged network elements; and
accept a signal to apply a control function to a device of said second set of devices.

14. The system as in claim 13, wherein said processor is to issue a signal to display said list, said display including a representation of port connecting said device of said second set of devices to said network infrastructure.

15. The system as in claim 14, wherein said processor is to display said list, said display including information about said device of said second set of devices and said accessing of said network infrastructure by said device of said second set of devices.

16. The system as in claim 14, wherein said processor is to accept said signal from an input device used to select said representation of said port.

17. The system as in claim 13, wherein said processor is to issue said signal requesting identifiers selected from the group of MAC addresses and IP addresses.

18. The system as in claim 13, wherein said processor is to accept as said signal a blocking function to block access to said network infrastructure of said device of said second set of devices.

19. A method of accepting a signal to block an unmanaged access of a device to a network infrastructure comprising:
collecting unique identifiers of devices accessing said network infrastructure;
eliminating from said collection, devices with managed access to said network infrastructure;
displaying a representation of a of said devices accessing said network infrastructure, said device with unmanaged access to said network infrastructure; and
accepting a signal applied to said display, said signal to block an access to said network infrastructure by said device with unmanaged access.

20. The method as in claim 19, wherein said collecting comprises collecting unique MAC addresses.
